(19) United States
(12) Patent Application Publication
(10) Pub. No.: US 2010/0079902 A1
(43) Pub. Date: Apr. 1, 2010

(54) CONTROLLER AND STORAGE DEVICE

(75) Inventor: Keiji Aruga, Machida (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/571,017

(22) Filed: Sep. 30, 2009

Related U.S. Application Data
(63) Continuation of application No. PCT/JP2007/060914, filed on May 29, 2007.

(51) Int. Cl. G11B 21/02

(52) U.S. Cl. 360/75; G9B/21.003

(57) ABSTRACT

According to one embodiment, in a controller of a servo system that performs positioning control of a head by feedback control includes a generating module and a notch filter. The generating module compares a target position and position information decoded from data read by the head from a recording medium to generate a position error signal. The notch filter performs notch filter processing to remove machine vibration of a head driving module on the position error signal. The transfer function H(s) of the notch filter is set to H(s)=[{s²+2kζωs+ω²}/{s²+2ζωs+ω²}]·[(τ₁s+1)] where s is a Laplace operator, k is a constant, τ₁ and τ₂ are time constants, ζ is a damping constant, and ω is a notch frequency.

### CROSS-REFERENCE TO RELATED APPLICATIONS

This application is a continuation of PCT international application Ser. No. PCT/JP2007/060914 filed on May 29, 2007 which designates the United States, incorporated herein by reference.

### BACKGROUND

1. Field

One embodiment of the invention relates to a controller and a storage device, and more particularly, to a controller that controls positioning of a head to a recording medium and a storage device with the controller.

2. Description of the Related Art

In disk devices typified by a hard disk device, feedback control is performed to control the positioning of head with respect to a disk. With the improvement in recording density of a disk, highly accurate head positioning control is required. The recording density includes track per inch (TPI) and bit per inch (BPI).

One example of a basic configuration of a conventional hard disk is described in, for example, Japanese Patent No. 2970679. In hard disk devices, a positioning signal written on a magnetic disk spinning at high speed is decoded, and this positioning signal is used in feedback control to attain required head positioning accuracy.

To improve the head positioning accuracy against a disturbance, the loop gain of the servo system needs to be increased. To increase the loop gain of the servo system is equivalent to increase the control band of the servo system. FIG. 1 is a diagram illustrating a relationship among position error signal (PES) of a head, disturbance D, disturbance transfer function H, and loop gain G of the servo system in a conventional hard disk device. As illustrated in FIG. 1, a positioning signal (or a signal indicating a target position of the head) is input to the servo system, and the output of the servo system is output to an actuator that drives an arm provided with the head. In this case, a relationship PES=(D·H)/(1+G) is satisfied.

To suppress the PES against various types of disturbances, generally, the loop gain of the servo system is set to be large. However, if the weight of the actuator is reduced to facilitate quick movement of the head, it becomes difficult to make the machine resonance frequency of the actuator high. If the loop gain of the serve system is increased in this state to improve the accuracy of the head positioning, the servo system becomes unstable, on the contrary. That is, if the machine resonance frequency of the actuator is low, the vibration reduces the head positioning accuracy, and therefore, there has been a limit to increase the gain of the servo system for the machine resonance frequency of the actuator.

To increase the gain of the servo system even if the actuator has machine resonance frequency, a notch filter is used in a conventional technology disclosed in, for example, Japanese Patent No. 2970679. Transfer function H(s) of the notch filter is expressed as follows:

H (s)={s²+2ζωs+ω²}/{s²+2ζωs+ω²}

where s is a Laplace operator, k is a constant, ζ is a damping constant, and ω is a notch frequency (center frequency). When a notch filter is used, the gain of the machine resonance frequency can be suppressed. However, the use of a notch filter causes a side effect, i.e., the occurrence of a phase error. The phase error is such a phenomenon that phase shift occurs at the center frequency, where a notch occurs in the gain-to-frequency characteristics of the notch filter, due to the use of a notch filter.

FIGS. 2A, 2B, 3A and 3B are charts for explaining an example of the phase shift. FIGS. 2A and 2B indicate gain-to-frequency characteristics and phase-to-frequency characteristics when the notch is relatively shallow and wide, respectively. FIGS. 3A and 3B indicate gain-to-frequency characteristics and phase-to-frequency characteristics when the notch is relatively deep and relatively narrow, respectively. In FIG. 2B, the phase shift at 2 kHz is approximately −1.1 degrees, and in FIG. 3B, the phase shift at 2 kHz is approximately −4.8 degrees. When a notch filter is used in which, for example, the notch center frequency co in the gain-to-frequency characteristics is set to 10 kHz, the phase error at 2 kHz is generally about 10 degrees, although it depends on the design of the notch filter. For example, when two such notch filters are used, a phase shift (phase delay) of about 20 degrees occurs. In this manner, the phase shift increases as the depth and width of the notch increase.

Conventional technologies have been proposed in this regard. For example, Japanese Patent Application Publication (KOKAI) No. H11-96704 discloses a method of setting a notch filter. Besides, Japanese Patent Application Publication (KOKAI) No. 2001-195850 discloses a resonance compensation filter. In addition, Japanese Patent Application Publication (KOKAI) No. H3-156720 discloses a servo-information detecting device for a varied servo system.

The machine resonance frequency of the actuator varies according to a temperature change, a secular change, and the like, and there are variations in machine resonance frequency among actuators. If the center frequency of the notch filter does not match the machine resonance frequency of the actuator due to changes or variations in the machine resonance frequency, the effect of using a notch filter is reduced.

However, as described above, the phase shift increases as the depth or width of the notch increases. Therefore, with the conventional technologies, it is difficult to keep the phase shift small if the effect of using a notch filter is to be maintained.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram for explaining a relationship among head positioning error, disturbance, disturbance transfer function, and loop gain of a servo system in a conventional hard disk device;

FIGS. 2A and 2B are exemplary charts for explaining an example of phase shift according to a conventional technology;

FIGS. 3A and 3B are exemplary charts for explaining an example of phase shift in the conventional technology;

FIG. 4 is an exemplary block diagram of a storage device according to an embodiment of the present invention;

FIG. 5 is an exemplary flowchart of notch filter processing performed by the storage device in the embodiment;

FIGS. 6A and 6B are exemplary charts of gain-to-frequency characteristics and phase-to-frequency characteristics of a notch filter in the embodiment;

FIGS. 7A and 7B are exemplary charts of frequency characteristics of an actuator in the embodiment;

FIGS. 8A and 8B are exemplary charts of frequency characteristics of a servo system when the notch filter of the embodiment is applied to the actuator having the frequency characteristics illustrated in FIGS. 7A and 7B in the embodiment; and

FIGS. 9A and 9B are exemplary charts of frequency characteristics of the servo system when an ordinary notch filter is used for a high-order peak in combination with the notch filter of the embodiment.

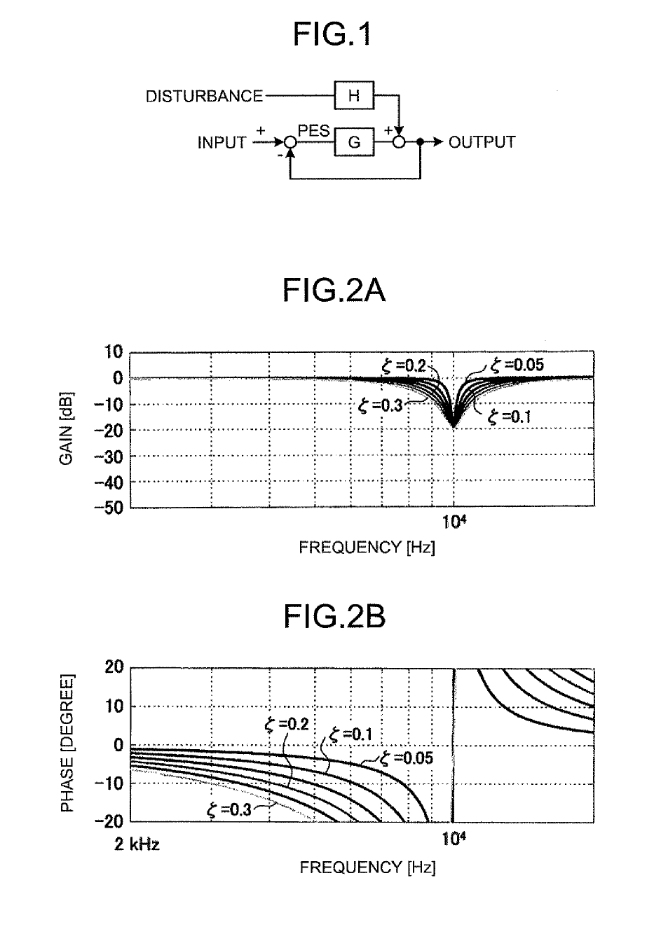

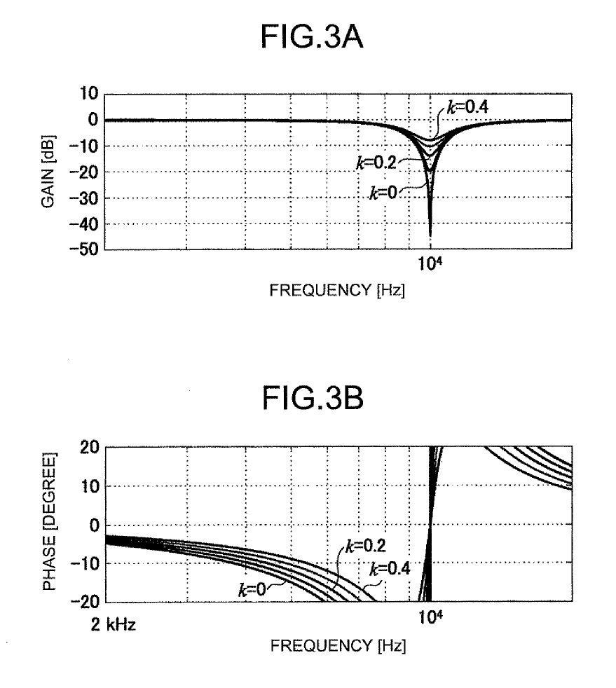

### DETAILED DESCRIPTION

Various embodiments according to the invention will be described hereinafter with reference to the accompanying drawings. In general, according to one embodiment of the invention, a controller of a servo system that performs positioning control of a head by feedback control comprises a generating module and a notch filter. The generating module is configured to compare a target position and position information decoded from data read by the head from a recording medium to generate a position error signal. The notch filter is configured to perform notch filter processing to remove machine vibration of a head driving module on the position error signal. The transfer function H(s) of the notch filter is set to H(s)=[{s²+2kζωs+ω²}/{s²+2ζωs+ω²}]·[(τ₁s+1)/(τ₂s+1)] where s is a Laplace operator, k is a constant, τ₁ and τ₂ are time constants, ζ is a damping constant, and ω is a notch frequency.

According to another embodiment of the invention, a storage device comprises a head driving module and a servo system. The head driving module is configured to drive a head. The servo system is configured to perform positioning control of the head by feedback control. The servo system comprises a generating module and a notch filter. The generating module is configured to compare a target position and position information decoded from data read by the head from a recording medium to generate a position error signal. The notch filter is configured to perform notch filter processing to remove machine vibration of the head driving module on the position error signal. The transfer function H(s) of the notch filter is set to H (s)=[{s²+2kζωs+ω²}/{s²+2ζωs+ω²}]·[(τ₁s+1)/(τ₂s+1)] where s is a Laplace operator, k is a constant, τ₁ and τ₂ are time constants, ζ is a damping constant, and ω is a notch frequency.

According to an embodiment of the invention, in a servo system in which positioning control for a head is performed by feedback control, the transfer function H(s) of a notch filter that removes machine vibration in a head driving module is set as follows:

H (s)=[{s²+2kζωs+ω²}/{s²+2ζωs+ω²}]·[(τ₁s+1)/(τ₂s+1)]

where s is a Laplace operator, k is a constant, τ₁ and τ₂ are time constants, ζ is a damping constant, and ω is a notch frequency (center frequency).

This reduces phase shift of the notch filter, thereby enabling highly-accurate head positioning.

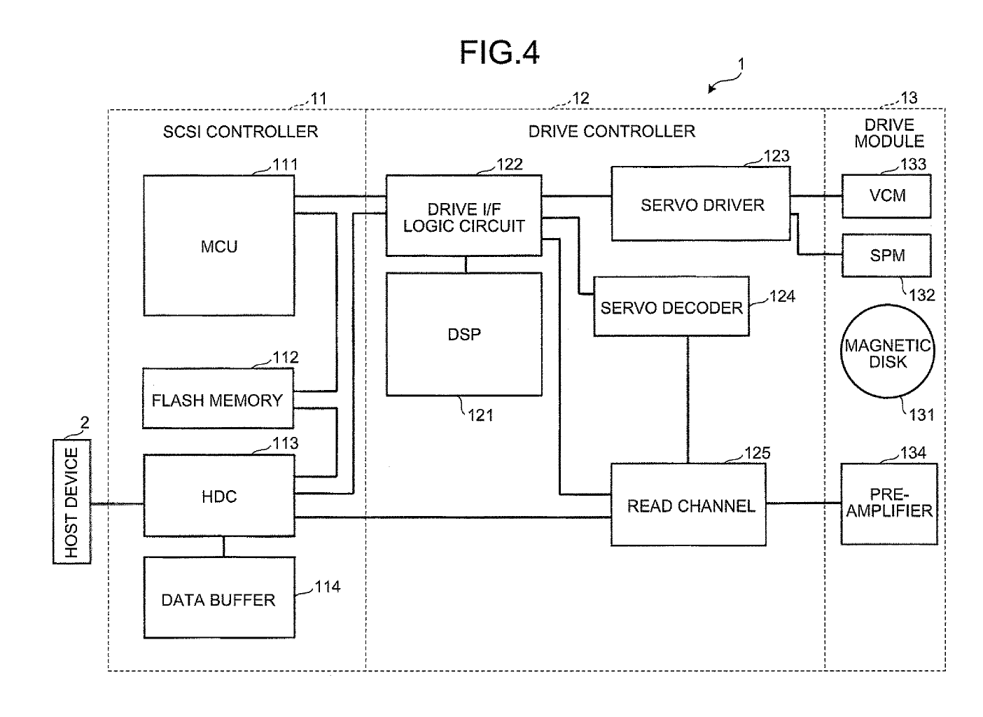

FIG. 4 is a block diagram of a storage device according to an embodiment of the invention.

As illustrated in FIG. 4, a hard disk device 1 writes data to a magnetic disk 131, or reads data from the magnetic disk 131 in response to a command from a host device 2. The hard disk device 1 comprises a small computer system interface (SCSI) controller 11, a drive controller 12, and a drive module 13.

The SCSI controller 11 comprises a micro controller unit (MCU) 111, a flash memory 112, a hard disk controller (HDC) 113, and a data buffer 114 such as a synchronous dynamic random access memory (SDRAM) or the like. The MCU 111 controls the overall operation of the hard disk device 1. The flash memory 112 stores a program executed by the MCU 111, data used by the MCU 111, and the like. The HDC 113 controls writing and reading of data with respect to the magnetic disk 131. The data buffer 114 temporarily stores data to be written to the magnetic disk 131 or data read from the magnetic disk 131.

The drive module 13 comprises the magnetic disk 131, a spindle motor (SPM) 132, a voice coil motor (VCM) 133, and a preamplifier 134. The SPM 132 turns or rotates the magnetic disk 131. The VCM 133 constitutes an actuator, i.e., a head driving module, and controls the position of the head (not illustrated) on the magnetic disk 131. Data to be written to the magnetic disk 131 is input to the head through, for example, the drive controller 12. Moreover, data read by the head from the magnetic disk 131 is input to a read channel 125 of the drive controller 12 through the preamplifier 134.

The drive controller 12 comprises a digital signal processor (DSP) 121, a drive interface (I/F) logic circuit 122, a servo driver 123, a servo decoder 124, and the read channel 125. The DSP 121 controls the SPM 132 and the VCM 133 in the drive module 13 through the drive I/F logic circuit 122 and the servo driver 123 under the control of the MCU 111. Because high speed processing is required in the servo system, the DSP 121 is provided separately from the MCU 111 to form so-called dual central processing unit (CPU) configuration. The read channel 125 inputs data read by the head from the magnetic disk 131 to the servo decoder 124. The servo decoder 124 decodes position information from the data and inputs it to the drive I/F logic circuit 122.

In the embodiment, the control of the VCM 133, i.e., the head positioning control, is performed by the DSP 121 under the control of the MCU 111. Upon this control of the VCM 133, the DSP 121 performs notch filter processing described later.

The basic configuration of the hard disk device 1 as illustrated in FIG. 4 is commonly known, and the detailed description thereof is omitted. It is needless to say that the basic configuration of the hard disk device 1 is not limited to the one illustrated in FIG. 4, and may take any form as long as it enables to perform the notch filter processing described later.

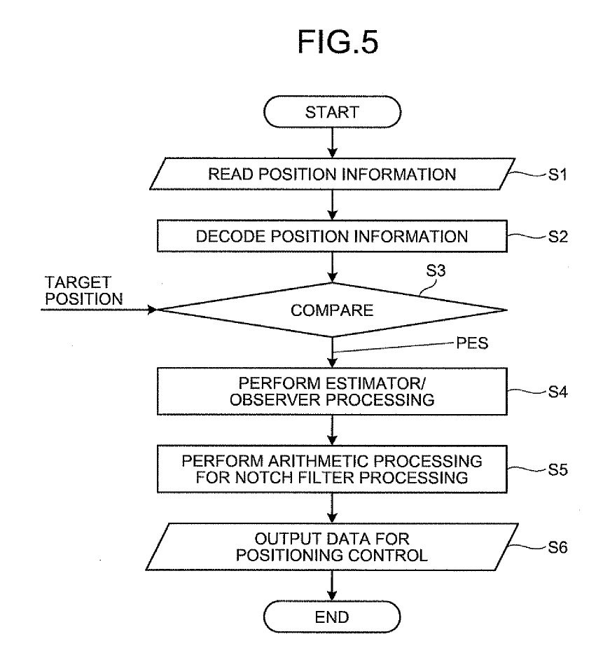

FIG. 5 is a flowchart of the notch filter processing performed in the hard disk device 1. The notch filter processing of FIG. 5 is performed by the DSP 121 that is appropriately programmed. The head positioning control is roughly classified into high-speed seek control and on-track control. For convenience' sake, the on-track control is explained herein. The processing in the high-speed seek control can be performed in the same manner as in the on-track control. The process from S1 to S6 in FIG. 5 is performed by corresponding functional components or modules in the DSP 121.

As illustrated in FIG. 5, when the head positioning control starts, at S1, position information (or a servo signal) written on the magnetic disk 131 for each sector on the magnetic disk 131 is read from among data read by the head from the magnetic disk 131. At S2, the read position information is decoded. In the embodiment, the cycle of the position information is, for example, about 22 μs, and arithmetic processing related to the notch filter processing performed in the DSP 121 is required to be performed within this time period of about 22 μs. At S3, the target position of the head and the decoded position information are compared to generate a PES of the head. At S4, data for the positioning control is generated using known processing such as estimator and observer.

At S5, arithmetic processing is performed to achieve the notch filter processing having the transfer function H(s) represented by a Laplace transform as follows:

H (s)=[{s²+2kζωs+ω²}/{s²+2ζωs+ω²}]·[(τ₁s+1)/(τ₂s+1)]

where s is a Laplace operator, k is a constant of, for example 0.05, τ₁ is a time constant of, for example, 2.2×10⁻⁶, τ₂ is a time constant of, for example, 1.2×10⁻⁵, ζ is a damping constant of, for example, 0.2, and ω is a notch frequency (center frequency) of, for example, 10 kHz. Besides, τ₁/τ₂ is, for example, approximately 4 to 6. As can be seen from this transfer function H(s), this notch filter is formed by combining a notch portion of a biquad notch filter and a phase compensation filter. At S5, the Laplace transform is converted into a Z transform for discrete processing to perform calculation. Therefore, the calculation is possible only with product-sum operation in the calculation of the Z transform, even though division is included in the Laplace transform. In addition, because calculation involved in the conversion into the Z transform can be achieved in a time period of, for example, about 1 μs to 2 μs, the load on the DSP 121 is small. Accordingly, time required for the notch filter processing to be achieved by the arithmetic processing of the DSP 121 is very short, and there is no harm in the operation of the servo system of which high-speed processing is required.

At S6, the data for the positioning control subjected to the notch filter processing at S5 is output to the servo driver 123 through the drive I/F logic circuit 122. Thus, the process ends. In the servo driver 123, the data for the positioning control subjected to the notch filter processing is input to a power amplifier through a digital/analog converter (DAC), and the output of the power amplifier is output to the VCM 133.

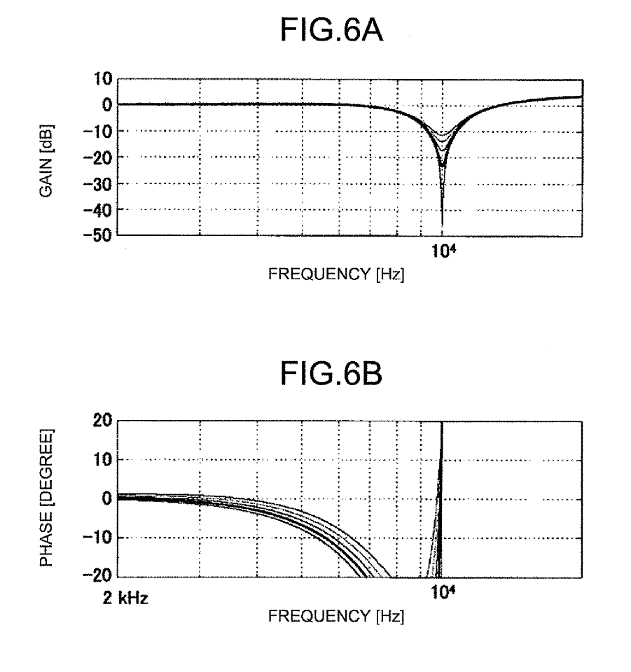

FIGS. 6A and 6B are charts of gain-to-frequency characteristics and phase-to-frequency characteristics of a notch filter achieved by the DSP 121 in the embodiment. FIG. 6A illustrates the gain-to-frequency characteristics. FIG. 6B illustrates the phase-to-frequency characteristics. In FIG. 6B, the phase shift at 2 kHz is about 0.2 degrees. In other words, compared to the conventional technology in which phase shift is 5 degrees, according to the embodiment, the phase shift can be reduced to approximately 0 degrees, and about 5 degrees of phase margin can be secured. In FIG. 6A, at frequencies higher than the notch frequency (center frequency) of 10 kHz, the gain increases by about 2 dB to 3 dB. This indicates that the combination of the embodiment with an actuator whose machine characteristics are unstable at high frequencies is not preferable. That is, according to the embodiment, if the machine characteristics of the actuator are not unstable at high frequencies, phase shift at low frequencies by the notch can be reduced to substantially 0 degree by the phase compensation using a read lag.

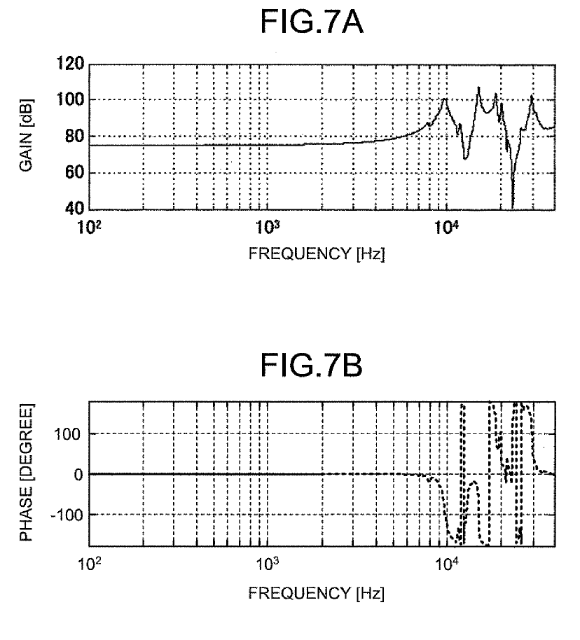

Generally, there is a main resonance frequency in the frequency characteristics of an actuator as illustrated in FIGS. 7A and 7B. It is often the case that at frequencies higher than the main resonance frequency, the main resonance frequency acts as a kind of low pass filter, resulting in reduction of the gain. FIGS. 7A and 7B illustrate frequency characteristics of an actuator. FIG. 7A illustrates the gain-to-frequency characteristics. FIG. 7B illustrates the phase-to-frequency characteristics. The actuator having such frequency characteristics may be suitably combined with the notch filter of the embodiment. On the other hand, an actuator having such frequency characteristics that high-order resonance has a large peak at frequencies higher than the main resonance may be not suitable to be combined with the notch filter of the embodiment.

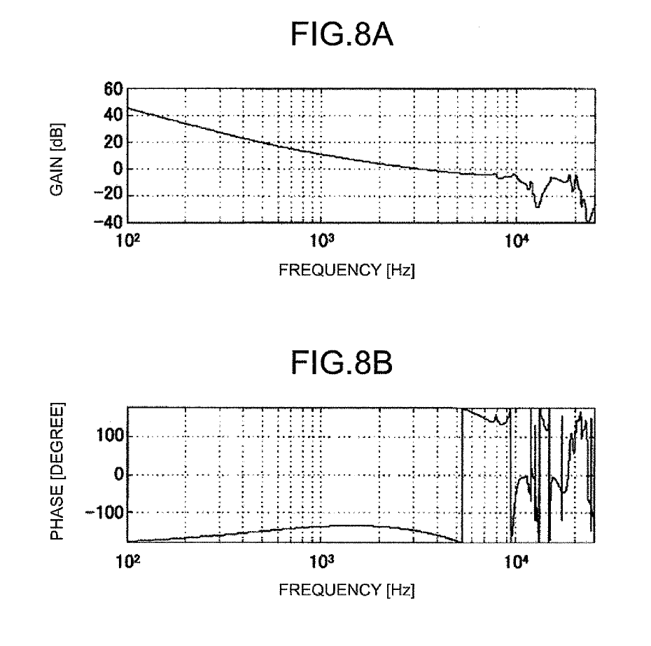

FIGS. 8A and 8B are charts of frequency characteristics of the servo system when the notch filter of the embodiment is applied to the actuator having the frequency characteristics illustrated in FIGS. 7A and 7B. In this case, the notch frequency o of the notch filter is set to be substantially equal to the main resonance frequency of the actuator, and the gain at frequencies higher than the notch frequency co is set according to antiresonance frequency of the actuator. FIG. 8A illustrates the gain-to-frequency characteristics of the servo system. FIG. 8B illustrates the phase-to-frequency characteristics. In FIG. 8A, although there are several high-order peaks at high frequencies, the peaks are relatively low. Therefore, this does not cause major problems, and it is realized that the phase margin at low frequencies can be secured for about 5 degrees.

FIGS. 8A and 8B illustrate open-loop characteristics of the servo system when the actuator having the frequency characteristics illustrated in FIGS. 7A and 7B is used. In FIGS. 8A and 8B, the zero cross frequency (band) is about 3.155 kHz, the gain margin is about 3.29 dB, and the phase margin is about 31.1 degrees, and it is confirmed that a wide band is achieved for, a 3.5 inch disk system, for example. According to the simulation conducted by the inventors, a control error is 23 nm, and it is confirmed that the positioning accuracy is improved in the embodiment by about 17% compared to a control error of 27 nm when the conventional notch filter is used under the same conditions.

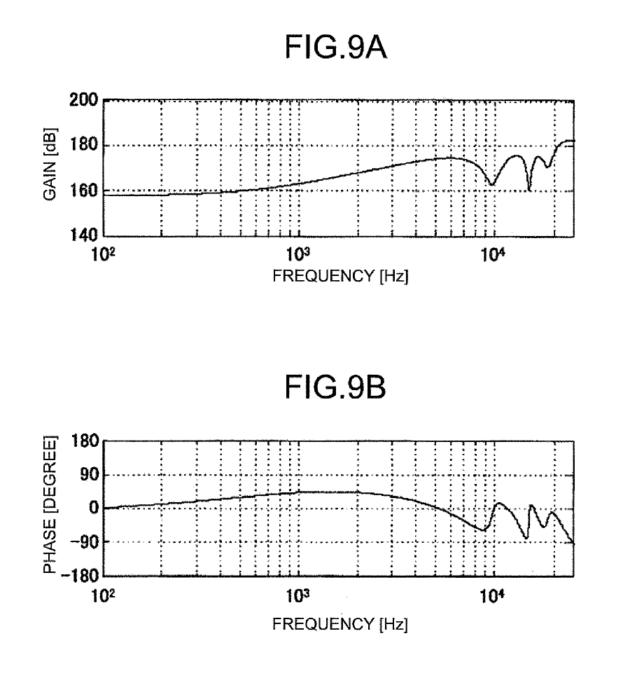

FIGS. 9A and 9B are charts of frequency characteristics of the servo system when an ordinary notch filter is used for a high-order peak in combination with the notch filter of the embodiment. The transfer function H(s) of the ordinary notch filter is represented as follows:

H(s)={s²+2kζωs+ω²}/{s²+2ζωs+ω²}

In this case, the notch frequency ω of the notch filter is set to be substantially equal to the main resonance frequency of the actuator, and the notch filter of the embodiment is combined with the ordinary notch filter that removes high-order resonance frequency of the actuator to form a hybrid notch filter. Such a hybrid notch filter can also be achieved by the DSP 121 that is appropriately programmed.

While, in the embodiment, the notch filter processing is described as being performed by the DSP 121 appropriately programmed, it is not so limited. For example, dedicated hardware, i.e., circuit, that performs the notch filter processing may be provided in the servo system that performs the head positioning control.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A controller of a servo system that performs positioning control of a head by feedback control, the controller comprising:
a generating module configured to compare a target position and position information decoded from data read by the head from a recording medium to generate a position error signal; and
a notch filter configured to perform notch filter processing to remove machine vibration of a head driving module on the position error signal, wherein
a transfer function H(s) of the notch filter is set to H(s)=[{s²+2kζωs+ω²}/{s²+2ζωs+ω²}]·[(τ₁s+1)/(τ₂s+1)] where s is a Laplace operator, k is a constant, τ₁ and τ₂ are time constants, ζ is a damping constant, and ω is a notch frequency.

2. The controller of claim 1, wherein τ₁/τ₂ is approximately 4 to 6.

3. The controller of claim 1, wherein
the notch frequency o of the notch filter is set to be substantially equal to a main resonance frequency of the head driving module, and
a gain at frequencies higher than the notch frequency co is set according to an antiresonance frequency of the head driving module.

4. The controller of claim 1, wherein
the notch frequency o of the notch filter is set to be substantially equal to a main resonance frequency of the head driving module, and
the notch filter includes a notch filter that removes high-order resonance frequency of the head driving module.

5. The controller of claim 1, wherein the notch filter is configured of a digital signal processor that performs the notch filter processing by arithmetic processing.

6. A storage device comprising:
a head driving module configured to drive a head; and
a servo system configured to perform positioning control of the head by feedback control, the servo system comprising
a generating module configured to compare a target position and position information decoded from data read by the head from a recording medium to generate a position error signal, and
a notch filter configured to perform notch filter processing to remove machine vibration of the head driving module on the position error signal, wherein
a transfer function H(s) of the notch filter is set to H(s)=[{s²+2kζωs+ω²}/{s²+2ζωs+ω²}]·[(τ₁s+1)/(τ₂s+1)] where s is a Laplace operator, k is a constant, τ₁ and τ₂ are time constants, ζ is a damping constant, and ω is a notch frequency.

7. The storage device of claim 6, wherein τ₁/τ₂ is approximately 4 to 6.

8. The storage device of claim 6, wherein
the notch frequency ω of the notch filter is set to be substantially equal to a main resonance frequency of the head driving module, and
a gain at frequencies higher than the notch frequency ω is set according to an antiresonance frequency of the head driving module.

9. The storage device of claim 6, wherein
the notch frequency ω of the notch filter is set to be substantially equal to a main resonance frequency of the head driving module, and
the notch filter includes a notch filter that removes high-order resonance frequency of the head driving module.

10. The storage device of claim 6, wherein the notch filter is configured of a digital signal processor that performs the notch filter processing by arithmetic processing.
